(19) United States
(12) Patent Application Publication
(10) Pub. No.: US 2025/0313778 A1
(43) Pub. Date: Oct. 9, 2025

(54) COMPOSITIONS FOR CLEANING METALS

(71) Applicant: Dow Global Technologies LLC, Midland, MI (US)

(72) Inventors: Xiaolin Ma, Shanghai (CN); Xue Chen, Manvel, TX (US)

(21) Appl. No.: 18/864,582

(22) PCT Filed: Jul. 28, 2022
(86) PCT No.: PCT/CN2022/108498

§ 371 Date: Nov. 11, 2024

(51) Int. Cl. C11D 3/30; C11D 3/33; C23G 5/036

(52) U.S. Cl. CPC C11D 3/30; C11D 3/33; C23G 5/036

(57) ABSTRACT

A process to clean a metal surface, the process comprising applying to the metal surface a composition comprising at least the following components a) and b), wherein component a is at least one ether amine selected from Formula 1A, as described herein, and/or at least one ether amine selected from Formula 1B, as described herein; and component b is at least one chelate. A composition comprising components a) and b), as discussed above.

### BACKGROUND OF THE INVENTION

Alkaline cleaning solutions are commonly used as metal cleaners for removal of different types of soils. These cleaners usually consist of alkalis, wetting agents, solvents and sequestrant (chelating) agents. Such cleaners should be able to efficiently clean the metal surface. Low foaming is another of the key criteria for the cleaners, because excess foam leads to rinsing problem and/or overflows that cause spills and product wastes. A quick recovery of the bath solution is another desired property for metal cleaners. The actives present in the cleaner need to efficiently separate from removed oils, otherwise, the cleaning power of the recycled bath is significantly reduced.

Inorganic alkalis (such as NaOH, KOH) and organic alkalis (such as monoethanol-amine) are widely used ingredients in metal cleaning solutions. However, such chemicals only provide alkalinity, and typically do not provide low foaming or a quick separation from oil. There is a need for metal cleaning compositions that provide low foaming and a fast oil separation, in addition to excellent cleaning performance.

International Publication WO2020/068481 discloses compositions containing alkyl ether amines used as foam control compounds in foodstuff processing. The alkyl ether amines are used at various stages during the industrial processing of vegetables, fruits, and plants, such as potatoes and beets. See Abstract. Foam control compounds are described, for example, on pages 4-7.

International Publication WO2017/011216 discloses glycol ether solvents in liquid cleaning compositions for the the removal of hydrophobic stains from hard surfaces, and also for the sudsing profile of the composition (see Abstract). The liquid cleaning composition also comprises a surfactant, and the composition has a pH less than 10 (see claim 1). The composition may also contain a chelate (see pages 13-14).

U.S. Publication 2018/0127688 discloses cleaning compositions containing an ester solvent, preferably a fatty acid methyl ester, in combination with one or more linear alkyl amines. The alkyl amines are disclosed as acting to remove and suspend organic oils, which have been burnt or adhered to a surface with heat, and these amines may be used alone as a soil removal agent. The cleaning compositions are disclosed for use in the cleaning of distillation towers associated with biofuel, and vegetable oil refining, and for use in cleaning ovens, food cooking surfaces and dry cleaning. See Abstract. The composition may contain a chelator (see, for example, paragraph [0043]).

U.S. Publication 2018/0291309 discloses a cleaning composition and process for cleaning post-chemical mechanical polishing (CMP) residue and contaminants from a microelectronic device (see Abstract). The composition contains of at least one organic amine, water, at least one pH adjusting agent, at least one organic additive, and at least one metal corrosion inhibitor (see claim 1). Some organic amines are disclosed, for example, in paragraph [0040].

International Publication WO93/16162 discloses an aqueous, hard surface cleaner that comprises the following: (a) an effective amount of a solvent selected from a C1-C6 alkanol, a C3-C24 alkylene glycol ether, and mixtures thereof; (b) an effective amount of a surfactant selected from amphoteric, non-ionic and anionic surfactants, and mixtures thereof; (c) an effective amount of a buffering system, which comprises a nitrogenous buffer selected from ammonium or alkaline earth carbamates, guanidine derivatives, alkoxylalkylamines and alkyleneamines; and (d) the remainder as substantially water (see Abstract). Some nitrogenous buffers are described on pages 10-11.

International Publication WO2015/143034 discloses an in-situ staged steam extraction method for removing petroleum products from a heavy oil or bitumen reservoir from subterranean locations. A steam composition may consist essentially of steam or may comprise one or more enhanced oil recovery agents. See Abstract. A glycol ether amine may be used as an enhanced oil recovery agent (see, for example, page 6, line 23, to page 7, line 6).

U.S. Pat. No. 9,574,126 discloses an aqueous based drilling fluid composition comprising a shale hydration inhibition agent of the formula H₂N—CH(R)—R1—O—R2, wherein R is hydrogen or an alkyl group having 1 to 12 carbons, R1 is an alkylene group having 1 to 12 carbons, and R2 is an alkyl group having 1 to 12 carbons (see Abstract). The shale hydration inhibition agent is present, in the aqueous based drilling fluid, in sufficient concentration to reduce the swelling of clays and shale, when exposed to a water-based drilling fluid (see Abstract).

However, as discussed above, there remains a need for metal cleaning compositions that provide low foaming and a fast oil separation, in addition to excellent cleaning performance. This need has been met by the following invention.

### SUMMARY OF THE INVENTION

In a first aspect, a process to clean a metal surface, the process comprising applying to the metal surface a composition comprising at least the following components a) and b):
a) at least one ether amine selected from Formula 1A and/or at least one ether amine selected from Formula 1B:

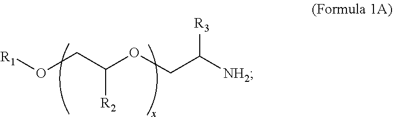

wherein R1 is a monovalent carbon-containing group comprising from 1 to 10 carbon atoms; R2 is a hydrogen, methyl, or ethyl; R3 is a hydrogen, methyl, or ethyl; and x is from 1 to 5; and when x≥2, the R2 groups of the —(CH₂—CHR2—O)— moieties may be all the same, or some or all different, and if some or all different, the —(CH₂—CHR₂—O)ₓ— moieties may contain any combination of hydrogen and/or methyl and/or ethyl as at least two different R2 groups;

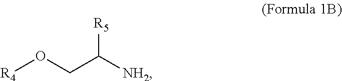

wherein R4 is a monovalent carbon-containing group comprising from 1 to 10 carbon atoms; and R5 is a hydrogen, methyl, or ethyl;
b) at least one chelate.

In a second aspect, a composition comprising at least the following components a) and b):
a) at least one ether amine selected from Formula 1A and/or at least one ether amine selected from Formula 1B:

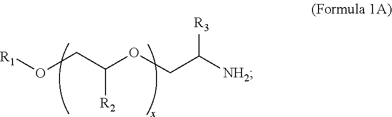

wherein R1 is a monovalent carbon-containing group comprising from 1 to 10 carbon atoms; R2 is a hydrogen, methyl, or ethyl; R3 is a hydrogen, methyl, or ethyl; and x is from 1 to 5; and when x≥2, the R2 groups of the —(CH₂—CHR₂—O)— moieties may be all the same, or some or all different, and if some or all different, the —(CH₂—CHR2—O)ₓ— moieties may contain any combination of hydrogen and/or methyl and/or ethyl as at least two different R2 groups;

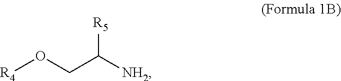

wherein R4 is a monovalent carbon-containing group comprising from 1 to 10 carbon atoms; and R5 is a hydrogen, methyl, or ethyl;
b) at least one chelate.

### BRIEF DESCRIPTION OF THE DRAWINGS

FIG. 1 is a bar graph showing the percentage of oil removal for the noted inventive and comparative compositions.

FIG. 2 is a bar graph showing the percentage of oil removal for the noted compositions.

FIG. 3 depicts a circulating foam tester.

FIG. 4A and FIG. 4B each depicts the “foam height versus time” profiles for the noted inventive and comparative compositions.

FIG. 5 is a bar graph showing the time for each noted composition to separate from oil and fill a volume of 5 ml or 10 ml.

### DETAILED DESCRIPTION OF THE INVENTION

Cleaning compositions have been discovered that provide excellent oil removal performance, good foam control and quick oil separation.

As discussed above, in a first aspect, a process to clean a metal surface is provided, the process comprising applying to the metal surface a composition comprising at least the following components a) and b), each as described herein. In a second aspect, a composition is provided, comprising at least the following components a) and b), each as described herein.

The above process may comprise a combination of two or more embodiments, as described herein. The above composition may comprise a combination of two or more embodiments, as described herein. Component a may comprise a combination of two or more embodiments, as described herein. Component b may comprise a combination of two or more embodiments, as described herein.

As used herein, in regard to Formula 1A or Formula 1B of component a, R1=R₁, R2=R₂, R3=R₃, R4=R₄ and R5=R₅. The following embodiments apply to both the first and second aspects of the invention, unless noted otherwise.

In one embodiment, or a combination of two or more embodiments, each described herein, the weight ratio of component a to component b is ≥0.40, or ≥0.50, or ≥0.60, or ≥0.70, or ≥0.80, or ≥0.90, or ≥1.0. In one embodiment, or a combination of two or more embodiments, each described herein, the weight ratio of component a to component b is ≤200, or ≤150, or ≤100, or ≤50, or ≤20, or ≤10, or ≤8.0, or ≤7.0, or ≤6.0, or ≤5.0, or ≤4.0.

In one embodiment, or a combination of two or more embodiments, each described herein, component b is a metal chelate.

In one embodiment, or a combination of two or more embodiments, each described herein, for Formula 1A, R1 is an alkyl group, further a C1-C5 alkyl group, further a C1-C4 alkyl group, further a C1-C3 alkyl group; and R2 is hydrogen or methyl and further methyl; and R3 is hydrogen or methyl; and for Formula 1B, R4 is an alkyl group, further a C1-C5 alkyl group, further a C1-C4 alkyl group, further a C1-C3 alkyl group; and R5 is hydrogen or methyl.

In one embodiment, or a combination of two or more embodiments, each described herein, the component a is selected from the following structures (1a) through (1j):

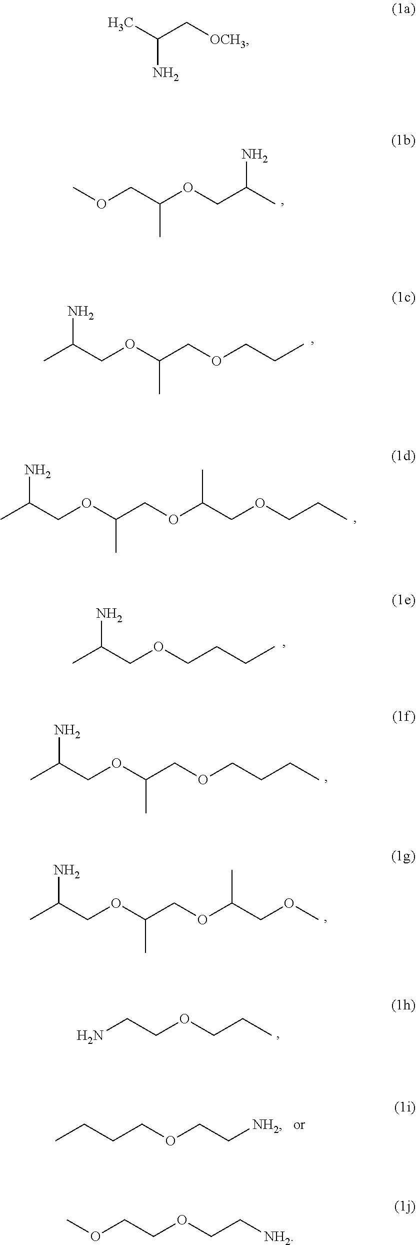

In one embodiment, or a combination of two or more embodiments, each described herein, the component a is selected from the following structures: (1a), (1b), (1c), (1d), (1e) or (1f), each as shown above.

In one embodiment, or a combination of two or more embodiments, each described herein, the component a is at least one ether amine selected from Formula 1A, and further one ether amine selected from Formula 1A.

In one embodiment, or a combination of two or more embodiments, each described herein, component a is at least one ether amine selected from Formula 1B, and further one ether amine selected from Formula 1B.

In one embodiment, or a combination of two or more embodiments, each described herein, the metal of the metal surface is selected from steel, stainless steel, brass, chrome, iron, aluminum, copper or gold.

In one embodiment, or a combination of two or more embodiments, each described herein, the composition further comprises water.

In one embodiment, or a combination of two or more embodiments, each described herein, the composition further comprises at least one surfactant as component c. In one embodiment, or a combination of two or more embodiments, each described herein, component c is selected from at least one non-ionic surfactant or at least one anionic surfactant or at least one cationic surfactant or at least one amphoteric surfactant, and further from at least one non-ionic surfactant or at least one anionic surfactant, and further from at least one non-ionic surfactant.

In one embodiment, or a combination of two or more embodiments, each described herein, the composition further comprises at least one alkaline salt as component d.

In one embodiment, or a combination of two or more embodiments, each described herein, the sum of component a and component b and water is present in an amount≥80 wt %, or ≥85 wt %, or ≥90 wt %, or ≥92 wt %, or ≥94 wt %, or ≥96 wt %, or ≥97 wt %, or 98 wt %, based on the weight of the composition. In one embodiment, or a combination of two or more embodiments, each described herein, the sum of component a and component b and water is present in an amount≤100 wt %, or ≤99 wt %, based on the weight of the composition.

### Component a—Ether Amine

Component a is described by Formula 1A or Formula 1B, each as shown above. For Formula 1A or Formula 1B, R1 or R4, each independently, include, but are not limited to, linear, branched, and cyclic alkyl groups such methyl; ethyl; propyl, isopropyl; butyl;

isobutyl; sec-butyl; tert-butyl; pentyl, hexyl; 1-methylbutyl; 2-methylbutyl; 3-methylbutyl; 1,1-dimethylpropyl; 1,2-dimethylpropyl; 2,2-dimethylpropyl; 1-ethyl-propyl; 1-methylpentyl; 2-methylpentyl; 3-methylpentyl; 4-methylpentyl; 1,1-dimethylbutyl; 1,2-dimethylbutyl; 1,3-dimethylbutyl; 2,2-dimethylbutyl; 2,3-dimethylbutyl; 3,3-dimethylbutyl; 1-ethylbutyl; 2-ethylbutyl; 1-ethyl-1-methylpropyl; 1,1,2-trimethylpropyl; 1,2,2-trimethylpropyl; heptyl; octyl; nonyl; decyl; cyclopentyl; methylcyclopentyl; cyclohexyl; methylcyclohexyl; ethylcyclohexyl; and propylcyclohexyl.

In one embodiment, or a combination of two or more embodiments, each described herein, for Formula 1A, R2 is methyl, R3 is methyl, and x=1 or 2. In one embodiment, or a combination of two or more embodiments, each described herein, for Formula 1B, R5 is methyl.

In one embodiment, or a combination of two or more embodiments, each described herein, component a is selected from any of the following groups (a) through (g):
(a) 2-methoxyethylamine, 2-ethoxyethylamine, 2-propoxyethylamine, 2-butoxy-ethyl-amine, 2-pentyloxyethylamine, 2-hexyloxyethylamine, 2-septyloxyethylamine, and 2-octyl-oxyethylamine;
(b) 1-methoxypropan-2-amine, 1-ethoxypropan-2-amine, 1-propoxypropan-2-amine, 1-butoxypropan-2-amine, 1-pentyloxypropan-2-amine, 1-hexyloxypropan-2-amine, 1-septyloxypropan-2-amine, and 1-octyloxypropan-2-amine;
(c) 2-(2-methoxyethoxy)-1-aminoethane, 2-(2-ethoxyethoxy)-1-aminoethane, 2-(2-propoxyethoxy)-1-aminoethane, 2-(2-butoxyethoxy)-1-aminoethane, 2-(2-pentyloxy-ethoxy)-1-aminoethane, and 2-(2-hexyloxyethoxy)-1-aminoethane;
(d) 1-(1-methoxyethoxy)-propan-2-amine, 1-(1-ethoxyethoxy)-propan-2-amine, 1-(1-propoxyethoxy)-propan-2-amine, 1-(1-butoxyethoxy)-propan-2-amine, 1-(1-pentyloxy-ethoxy)-propan-2-amine, and 1-(1-hexyloxyethoxy)-propan-2-amine;
(e) 1-((1-methoxypropan-2-yl)oxy)-propan-2-amine, 1-((1-ethoxypropan-2-yl)-oxy)-propan-2-amine, 1-((1-propoxypropan-2-yl)oxy)-propan-2-amine, 1- ((1-butoxy-propan-2-yl)oxy)-propan-2-amine, 1-((1-pentyloxypropan-2-yl)oxy)-propan-2-amine, and 1-((1-hexyloxypropan-2-yl)oxy)-propan-2-amine;
(f) 2-[2-(2-methoxy-ethoxy)-ethoxy]-ethylamine, 2-[2-(2-ethoxy-ethoxy)-ethoxy]-ethylamine, 2-[2-(2-propoxy-ethoxy)-ethoxy]-ethylamine, 2-[2-(2-butoxy-ethoxy)-ethoxy Jethylamine, 2-[2-(2-pentyloxy-ethoxy)-ethoxy]-ethylamine, 2-[2-(2-hexyloxy-ethoxy)-ethoxy]-ethylamine; and
(g) 1-(((1-methoxy (propan-2-yl)oxy)-propan-2-yl)oxy)-propan-2-amine, 1-(((1-ethoxy (propan-2-yl)oxy)-propan-2-yl)oxy)-propan-2-amine, 1-(((1-propoxy (propan-2-yl)oxy)-propan-2-yl)oxy)-propan-2-amine, 1-(((1-butoxy (propan-2-yl)oxy)-propan-2-yl)oxy)-propan-2-amine, 1-(((1-pentyloxy (propan-2-yl)oxy)-propan-2-yl)oxy)-propan-2-amine, and 1-(((1-hexyloxy (propan-2-yl)oxy)-propan-2-yl)oxy)-propan-2-amine.

In one embodiment, or a combination of two or more embodiments, each described herein, component a has a boiling point from 80° C. to 290° C., further from 85° C. to 285° C., further from 90° C. to 280° C.

Syntheses of the ether amines are known in the art, and various ether amines are also commercially available. For example, 1-methoxypropan-2-amine is available from Sigma-Aldrich. One mode of synthesis involves the reductive amination of glycol ethers with ammonia, using NiCoCuReB catalyst, as described in U.S. Pat. No. 9,574,126. Glycol ether starting materials can be obtained from The Dow Chemical Company, such as those obtained under the DOWANOL, CELLOSOLVE, and CARBITOL tradenames, such as propylene glycol n-butyl ether (DOWANOL PnB glycol ether), dipropylene glycol methyl ether (DOWANOL DPM glycol ether), dipropylene glycol n-propyl ether (DOWANOL DPnP glycol ether), propylene glycol n-propyl ether (DOWANOL PnP glycol ether), dipropylene glycol n-butyl ether (DOWANOL DPnB glycol ether), ethylene glycolmono-hexyl ether (Hexyl CELLOSOLVE solvent), ethylene glycol mono-n-propyl ether (propyl CELLOSOLVE solvent), diethylene glycol monohexyl ether, ethylene glycol mono-n-propyl ether (Propyl CELLOSOLVE solvent), diethylene glycol monohexyl ether (Hexyl CARBITOL solvent), diethylene glycol monobutyl ether (Butyl CARBITOL Solvent) and triethylene glycol monobutyl ether.

Component a can be in the form of a liquid composition that is added to an aqueous composition. The ether amine per se can be in the form of a liquid at room temperature (23° C.), and therefore a “stock” composition can be one where the ether amine is in neat form (100% wt). A stock composition can also be prepared with the ether amine in one or more compatible solvents, such as, for example, where the ether amine is present in an amount in the range of about 30% (wt) to about 99% (wt). The ether amine may be in the form of a solid composition, such as in powder or granule form that can be added to an aqueous composition.

### Component b—Chelate

Chelates are known in the art. A chelate typically comprises at least two ligand that are bonded to a central metal atom. Chelates include, but are not limited to, salts of ethylene diamine tetraacetic acid and the derivatives thereof; aminocarboxylate chelants, such as a salt of glutamic-N,N-diacetic acid; phosphonate chelating agents, such as ethylene diamine tetramethylene phosphonates, and diethylene triamine pentamethylene phosphonates. These chelates may be present either in their acid form or as salts. Biodegradable chelating agents include, but are not limited to, ethylene diamine N,N′-disuccinic acid, or alkali metal, or alkaline earth metal, ammonium or substitutes ammonium salts thereof, or mixtures thereof; and L-glutamic acid N,N-diacetic acid (GLDA) commercially available under tradename DISSOLVINE 47S from Akzo Nobel.

Suitable amino carboxylates include ethylene diamine tetra acetates, diethylene triamine pentaacetates, diethylene triamine pentaacetate (DTPA), N-hydroxyethylethylene-diamine triacetates, nitrilotriacetates, ethylenediamine tetrapropionates, triethylenetetramine-hexaacetates, ethanoldiglycines, and methyl glycine diacetic acid (MGDA), both in their acid form, or in their alkali metal, ammonium, and substituted ammonium salt forms. Particularly suitable amino carboxylates include, but are not limited to, salts of ethylene diamine tetraacetic acid (EDTA); EDTA; propylene diamine tetracetic acid (PDTA) which is, for instance, commercially available from BASF under the trade name TRILON FS; methylglycine di-acetic acid (MGDA); and diethylene triamine pentaacetate (DTPA) from BASF. Further carboxylate chelating agents include salicylic acid, aspartic acid, glutamic acid, glycine, malonic acid or mixtures thereof.

In one embodiment, or a combination of two or more embodiments, each described herein, component b is an ethylene diamine tetraacetic acid, or a salt thereof, such as EDTA-4Na·H2O.

### Component c—Surfactant

Surfactants include, but are not limited to, are anionic, cationic, amphoteric and non-ionic compounds. A combination of two or more of these surfactants may be used; for example, a cationic may be used with a non-ionic, or an anionic used with a non-ionic.

Cationic surfactants include, but are not limited to, salts of long chain primary, secondary or tertiary amines, such as oleylamide acetate, cetylamine acetate, sterateamine acetate, didodecyl-amine lactate, the acetate of aminoethyl-aminoethyl stearamide, dilauroyl triethylene tetramine diacetate, 1-aminoethyl-2-heptadecenyl imidazoline acetate; and quaternary salts, such as cetylpyridinium bromide, hexadecyl ethyl morpholinium chloride, and diethyl di-dodecyl ammonium chloride. Examples of cationic surfactants include alkyltrimethylammonium salts.

Anionic surfactants include, but are not limited to, alkali metal salts of alkyl-aryl sulfonic acids; sodium dialkyl sulfosuccinate, sulfated or sulfonated oils, for example, sulfated castor oil; sulfonated tallow, and alkali salts of short chain petroleum sulfonic acids; ammonium and amine soaps; the fatty acid part of such soaps contains preferably at least 16 carbon atoms. The soaps can also be formed “in situ;” in other words, a fatty acid can be added to an oil phase and an alkaline, material to an aqueous phase. Anionic surfactants also include, but are not limited to, alkyl sulfates, alkyether sulfates, sulfated alkanolamides, alpha olefin sulfonates, lignosulfonates, sulfosuccinates, fatty acid salts, and phosphate esters. For example, an anionic surfactant is DOWFAX C10L, commercially available from The Dow Chemical Company.

Examples of non-ionic surfactants include, but are not limited to, alkoxylated alcohols, alkoxylated alkyl phenols, fatty acid esters, amine and amide derivatives, alkylpoly-glucosides, ethylene oxide/propylene oxide copolymers, polyols and alkoxylated polyols. For example, a non-ionic surfactant is TERGITOL L-62, commercially available from The Dow Chemical Company. In general, non-ionic surfactants include, but are not limited to, the following: a) condensation products of higher fatty alcohols with ethylene oxide; b) condensation products of alkylphenols with ethylene oxide; c) condensation products of higher fatty acid amides with five, or more, ethylene oxide units; d) polyethylene glycol esters of long chain fatty acids, such as tetraethylene glycol monopalmitate, hexaethylene-glycol monolaurate, nonaethyleneglycol monostearate, nonaethyleneglycol dioleate, tridecaethyleneglycol monoarachidate, tricosaethyleneglycol monobehenate, tricosaethyleneglycol dibehenate; e) polyhydric alcohol partial higher fatty acid esters such as sorbitan tristearate; f) ethylene oxide condensation products of polyhydric alcohol partial higher fatty acid esters, and their inner anhydrides; g) long chain polyglycols in which one hydroxyl group is esterified with a higher fatty acid and other hydroxyl group is etherified with a low molecular alcohol, such as methoxypolyethylene glycol 550 monostearate (550 meaning the average molecular weight of the polyglycol ether).

Amphoteric surfactants include, but are not limited to, alkylamidopropylamine N-oxide, alkyldimethylamine N-oxide, alkylbetaine, alkylamidopropylbetaine, cocamidopropyl betaine, cocoamphoacetate and cocoamphodiacetate.

In one embodiment, or a combination of two or more embodiments, each described herein, component c is an alcohol alkoxylate, such as, for example, an ethoxylated propoxylated alkanol, and further ethoxylated propoxylated 2-ethyl-1-hexanol.

### Component d—Alkaline Salt

An alkaline salt is the product of a strong base and a weak acid, and which can form basic solution upon dissolution in water. Alkaline salts include, but are not limited to, sodium carbonate, sodium acetate, sodium hydroxide, sodium bicarbonate, sodium chloride, and sodium sulfide.

In one embodiment, or a combination of two or more embodiments, each described herein, component d is selected from a metal bicarbonate, a metal carbonate, a metal chloride, a metal chlorate, a metal nitrate, a metal phosphate, a metal sulfate, a metal sulfide, or a mixture thereof.

### Other Additives

An inventive composition may optionally include one or more additional additive(s). Examples of additives include, but are not limited to, block or random copolymers of ethylene oxide/propylene oxide, butylene oxide/propylene oxide, ethylene oxide/butylene oxide; waxes; silicone-based materials; foam control compounds, such as agents produced by the alkoxylation of alcohol(s), alkyl polyglucosides, ketal foam control agents, and cellulose derivative foam control agents.

### DEFINITIONS

Unless stated to the contrary, implicit from the context, or customary in the art, parts and percents are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer,” as used herein, refers to a polymer prepared by the polymerization of at least two different types of monomers. The term interpolymer thus includes the term copolymer (employed to refer to polymers prepared from two different types of monomers) and polymers prepared from more than two different types of monomers.

The phrase “applying to the metal surface,” in reference to the process of cleaning a metal surface with a composition, described herein, refers to the act of contacting the metal surface with the composition. This contact may occur by wetting the metal surface with the composition using a spray, a brush, a roller, or by dipping the metal into the composition, or by any other means known in the art.

The phrase “monovalent carbon-containing group comprising from 1 to 10 carbon atoms,” as used herein in reference to R1 of Formula 1A and R4 of Formula 1B, refers to a chemical group that comprises from 1 to 10 carbon atoms, and which group is bonded to the remainder of Formula 1A (for R1) or the remainder of Formula 1B (for R4) via a single bond (i.e., R1- or R4-). This chemical group may be, for example, a linear aliphatic group, a branched aliphatic group, a cyclic aliphatic group, an aromatic group (for example,

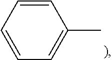

a combination of a linear aliphatic and cyclic aliphatic group, a combination of a branched aliphatic and a cyclic aliphatic group, a combination of a linear aliphatic and an aromatic group, a combination of a branched aliphatic and an aromatic group, or other combinations known in the art. Also, in regard to the number of carbon atoms in R1 of Formula 1A, or in R4 of Formula 1B, the notation “C1-C10,” for example, where “1 through 10” represents consecutive numbers from 1 to 10, refers to the numerical range of carbon atoms that may be present in the respective R group.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure, not specifically delineated or listed.

### Listing of Some Process and Composition Features

A] A process to clean a metal surface, the process comprising applying to the metal surface a composition comprising at least the following components a) and b);
a) at least one ether amine selected from Formula 1A and/or at least one ether amine selected from Formula 1B:

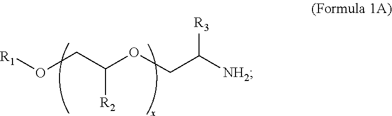

wherein R1 is a monovalent carbon-containing group comprising from 1 to 10 carbon atoms; R2 is a hydrogen, methyl, or ethyl; R3 is a hydrogen, methyl, or ethyl; and x is from 1 to 5; and when x≥2, the R2 groups of the —(CH₂—CHR2—O)— moieties may be all the same, or some or all different, and if some or all different, the —(CH₂—CHR2—O)ₓ— moieties may contain any combination of hydrogen and/or methyl and/or ethyl as at least two different R2 groups;

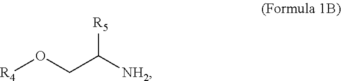

wherein R4 is a monovalent carbon-containing group comprising from 1 to 10 carbon atoms; and R5 is a hydrogen, methyl, or ethyl;
b) at least one chelate.

B] The process of A] above, where the weight ratio of component a to component b is ≥0.40, or ≥0.50, or ≥0.60, or ≥0.70, or ≥0.80, or ≥0.90, or ≥1.0.

C] The process of A] or B] above, where the weight ratio of component a to component b is ≤200, or ≤150, or ≤100, or ≤50, or ≤20, or ≤10, or ≤8.0, or ≤7.0, or ≤6.0, or ≤5.0, or ≤4.0.

D] The process of any one of A]-C] (A] through C]) above, where, for Formula 1A, when x≥2, the R2 groups of the —(CH₂—CHR2—O)— moieties are all the same,

E] The process of any one of A]-C] above, where, for Formula 1A, when x≥2, the R2 groups of the —(CH₂—CHR2—O)— moieties are some or all different, and the —(CH₂—CHR2—O)ₓ— moieties may contain any combination of hydrogen and/or methyl and/or ethyl as at least two different R2 groups.

F] The process of any one of A]-E] above, where component b is a metal chelate.

G] The process of any one of A]-F] above, where component b is comprises a metal salt of ethylene diamine tetraacetic acid.

H] The process of any one of A]-G] above, where, for Formula 1A, R1 is an alkyl group, further a C1-C5 alkyl group, further a C1-C4 alkyl group, further a C1-C3 alkyl group; and R2 is hydrogen or methyl and further methyl; and R3 is hydrogen or methyl; and
for Formula 1B, R4 is an alkyl group, further a C1-C5 alkyl group, further a C1-C4 alkyl group, further a C1-C3 alkyl group; and R5 is hydrogen or methyl.

I] The process of any one of A]-H] above, where, for Formula 1A, x=1 or 2.

J] The process of any one of A]-I] above, where, for Formula 1A, x=1 or 2, and if x=2, then the R2 of each —(CH₂—CHR2—O)— moiety is the same.

K] The process of any one of A]-J] above, where component a is selected from the following structures (1a) through (1j):

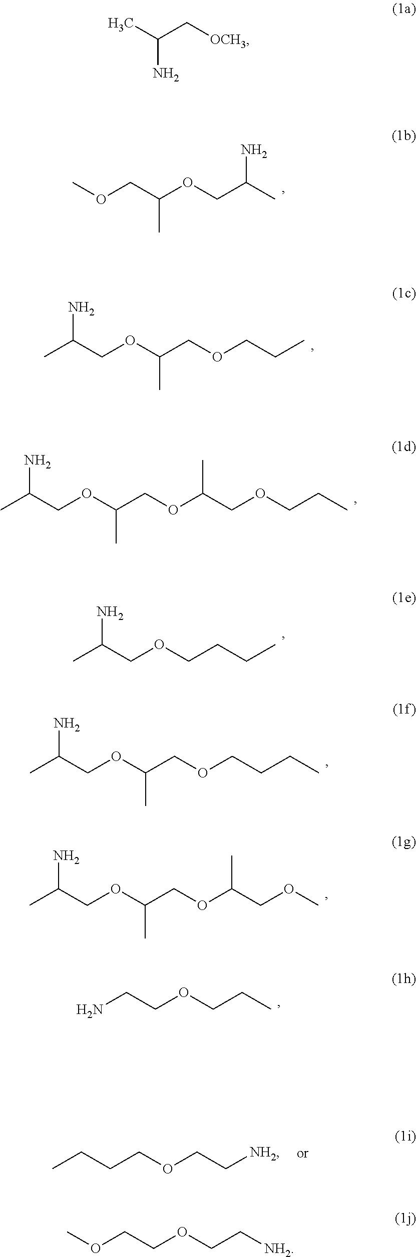

L] The process of any one of A]-K] above, where component a is selected from the following structures: (1a), (1b), (1c), (1d), (1e) or (1f), each as shown above.

M] The process of any one of A]-L] above, where component a is at least one ether amine selected from Formula 1A or at least one ether amine selected from Formula 1B.

N] The process of any one of A]-L] above, where component a is at least one ether amine selected from Formula 1A and at least one ether amine selected from Formula 1B.

O] The process of any one of A]-M] above, where component a is at least one ether amine selected from Formula 1A, and further one ether amine selected from Formula 1A.

P] The process of any one of AJ-M] above, where component a is at least one ether amine selected from Formula 1B, and further one ether amine selected from Formula 1B.

Q] The process of any one of A]-P] above, where the metal of the metal surface is selected from steel, stainless steel, brass, chrome, iron, aluminum, copper or gold.

R] The process of any one of A]-Q] above, where the temperature of the composition is from 20° C. to 30° C. when applied to the metal surface.

A2] A composition comprising at least the following components a) and b):
a) at least one ether amine selected from Formula 1A and/or at least one ether amine selected from Formula 1B:

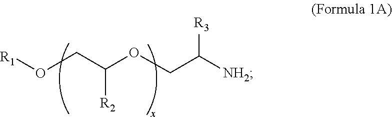

wherein R1 is a monovalent carbon-containing group comprising from 1 to 10 carbon atoms; R2 is a hydrogen, methyl, or ethyl; R3 is a hydrogen, methyl, or ethyl; and x is from 1 to 5; and when x≥2, the R2 groups of the —(CH₂—CHR2—( ) moieties may be all the same, or some or all different, and if some or all different, the —(CH₂—CHR2—O)ₓ— moieties may contain any combination of hydrogen and/or methyl and/or ethyl as at least two different R2 groups;

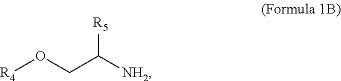

wherein R4 is a monovalent carbon-containing group comprising from 1 to 10 carbon atoms; and R5 is a hydrogen, methyl, or ethyl;
b) at least one chelate.

B2] The composition of A2] above, where the weight ratio of component a to component b is ≥0.40, or ≥0.50, or ≥0.60, or ≥0.70, or ≥0.80, or ≥0.90, or ≥1.0.

C2] The composition of A2] or B2] above, where the weight ratio of component a to component b is ≤200, or ≤150, or ≤100, or ≤50, or ≤20, or ≤10, or ≤8.0, or ≤7.0, or ≤6.0, or ≤5.0, or ≤4.0.

D2] The composition of any one of A2]-C2] above, where, for Formula 1A, when x≥2, the R2 groups of the —(CH₂—CHR2—O)— moieties are all the same.

E2] The composition of any one of A2]-C2] above, where, for Formula 1A, when x≥2, the R2 groups of the —(CH₂—CHR2—O)— moieties are some or all different, and the —(CH₂—CHR2—O)ₓ— moieties may contain any combination of hydrogen and/or methyl and/or ethyl as at least two different R2 groups.

F2] The composition of any one of A2]-E2] above,, where component b is a metal chelate.

G2] The composition of any one of A2]-F2] above, where component b is comprises a metal salt of ethylene diamine tetraacetic acid.

H2] The composition of any one of A2]-G2] above, where, for Formula 1A, R1 is an alkyl group, further a C1-C5 alkyl group, further a C1-C4 alkyl group, further a C1-C3 alkyl group; and R2 is hydrogen or methyl and further methyl; and R3 is hydrogen or methyl; and for

Formula 1B, R4 is an alkyl group, further a C1-C5 alkyl group, further a C1-C4 alkyl group, further a C1-C3 alkyl group; and R5 is hydrogen or methyl.

I2] The composition of any one of A2]-H2] above, where, for Formula 1A, x=1 or 2.

J2] The composition of any one of A2]-12] above, where, for Formula 1A, x=1 or 2, and if x=2, then the R2 of each —(CH₂—CHR2—O)— moiety is the same.

K2] The composition of any one of A2]-12] above, where component a is selected from the following structures (1a) through (1j), each as shown above.

L2] The composition of any one of A2]-K2] above, where component a is selected from the following structures: (1a), (1b), (1c), (1d), (1e) or (1f), each as shown above.

M2] The composition of any one of A2]-L2] above, where component a is at least one ether amine selected from Formula 1A or at least one ether amine selected from Formula 1B.

N2] The composition of any one of A2]-L2] above, where component a is at least one ether amine selected from Formula 1A and at least one ether amine selected from Formula 1B.

O2] The composition of any one of A2]-M2] above, where component a is at least one ether amine selected from Formula 1A, and further one ether amine selected from Formula 1A.

P2] The composition of any one of A2]-M2] above, where component a is at least one ether amine selected from Formula 1B, and further one ether amine selected from Formula 1B.

Q2] The composition of any one of A2]-P2] above, where the composition is used to clean metal surfaces.

R2] The composition of Q2] above, where the metal of the metal surface is selected from steel, stainless steel, brass, chrome, iron, aluminum, copper or gold.

A3] The process of any one of A]-R] above, or the composition of any one of A2]-R2] above, where the composition further comprises water.

B3] The process of any one of A]-R] or A3] above, or the composition of any one of A2]-R2] or A3] above, where the composition further comprises at least one surfactant as component c.

C3] The process of B3] above, or the composition of B3] above, where the component c is present in an amount≥0.01 wt %, or ≥0.02 wt %, or ≥0.04 wt %, or ≥0.06 wt %, or ≥0.08 wt %, based on the weight of the composition.

D3] The process of B3] or C3] above, or the composition of B3] or C3] above, where the component c is present in an amount≤5.0 wt %, or ≤4.0 wt %, or ≤3.0 wt %, or ≤2.0 wt %, or ≤1.0 wt %, or ≤0.8 wt %, or ≤0.6 wt %, or ≤0.4 wt %, or ≤0.2 wt %, or ≤0.1 wt %, based on the weight of the composition.

E3] The process of any one of B3]-D3] above, or the composition of any one of B3]-D3] above, where the component c is selected from at least one non-ionic surfactant or at least one anionic surfactant or at least one cationic surfactant or at least one amphoteric surfactant, and further from at least one non-ionic surfactant or at least one anionic surfactant, and further from at least one non-ionic surfactant.

F3] The process of any one of A]-R] or A3]-E3] above, or the composition of any one of A2]-R2] or A3]-E3] above, where the composition further comprises at least one alkaline salt as component d.

G3] The process of F3] above, or the composition of F3] above, where the component d is present in an amount≥0.05 wt %, or ≥0.10 wt %, or ≥0.20 wt %, or ≥0.30 wt %, or ≥0.40 wt %, or ≥0.50 wt %, based on the weight of the composition.

H3] The process of F3] or G3] above, or the composition of F3] or G3] above, where the component d is present in an amount≤20 wt %, or ≤10 wt %, or ≤5.0 wt %, or ≤4.0 wt %, or ≤3.0 wt %, or ≤2.0 wt %, or ≤1.0 wt %, based on the weight of the composition.

I3] The process of any one of A]-RJ or A3]-H3] above, or the composition of any one of A2]-R2] or A3]-H3] above, where each ether amine of component a independently has a molecular weight≥60, or ≥65, or 70 wt %, or ≥75, or ≥80, or ≥85 g/mol.

J3] The process of any one of A]-R] or A3]-13] above, or the composition of any one of A2]-R2] or A3]-13] above, where each ether amine of component a independently has a molecular weight≤500, or ≤450, or ≤400, or ≤350, or ≤300, or ≤250 g/mol.

K3] The process of any one of A]-R] or A3]-J3] above, or the composition of any one of A2]-R2] or A3]-J3] above, where the sum of component a and component b is present in an amount≥0.50 wt %, or ≥1.0 wt %, or ≥1.5 wt %, or ≥2.0 wt %, based on the weight of the composition.

L3] The process of any one of A]-RJ or A3]-K3] above, or the composition of any one of A2]-R2] or A3]-K3] above, where the sum of component a and component b is present in an amount≤10 wt %, or ≤9.0 wt %, or ≤8.0 wt %, or ≤7.0 wt %, or ≤6.0 wt %, or ≤5.0 wt %, or ≤4.0 wt %, or ≤3.0 wt %, based on the weight of the composition.

M3] The process of any one of B3]-L3] above, or the composition of any one of B3]-L3] above, where the sum of component a and component c is present in an amount≥0.50 wt %, or ≥1.0 wt %, or ≥1.5 wt %, or ≥2.0 wt %, based on the weight of the composition.

N3] The process of any one of B3]-M3] above, or the composition of any one of B3]-M3] above, where the sum of component a and component c is present in an amount≤10 wt %, or ≤8.0 wt %, or ≤6.0 wt %, or ≤4.0 wt %, or ≤3.0 wt %, based on the weight of the composition.

O3] The process of any one of A]-R] or A3]-N3] above, or the composition of any one of A2]-R2] or A3]-N3] above, where the sum of component a and component b and water is present in an amount≥80 wt %, or ≥85 wt %, or ≥90 wt %, or ≥92 wt %, or ≥94 wt %, or ≥96 wt %, or ≥97 wt %, or ≥98 wt %, based on the weight of the composition.

P3] The process of any one of A]-RJ or A3]-03] above, or the composition of any one of A2]-R2] or A3]-03] above, where the sum of component a and component b and water is present in an amount≤100 wt %, or ≤99 wt %, based on the weight of the composition.

Q3] The process of any one of B3]-P3] above, or the composition of any one of B3]-P3] above, where the sum of component a, component b, component c and water is present in an amount≥85 wt %, or ≥90 wt %, or ≥92 wt %, or ≥94 wt %, or ≥96 wt %, or ≥97 wt %, or ≥98 wt %, based on the weight of the composition.

R3] The process of any one of B3]-Q3] above, or the composition of any one of B3]-Q3] above, where the sum of component a, component b, component c and water is present in an amount≤100 wt %, or ≤99 wt %, based on the weight of the composition.

S3] The process of any one of A]-R] or A3]-R3] above, or the composition of any one of A2]-R2] or A3]-R3] above, where the composition has an “oil removal %”≥40%, or ≥45%, or ≥50%, or ≥52%, or ≥54%, or ≥56%, or ≥58%, or ≥60%, as determined from the equation [(W2−W3)/(W2−W1)]×100, where W1, W2 and W3 are each defined herein (see experimental section).

T3] The process of any one of A]-R] or A3]-S3] above, or the composition of any one of A2]-R2] or A3]-S3] above, where the composition has an “oil removal %”≤100%.

U3] The process of any one of A]-R] or A3]-T3] above, or the composition of any one of A2]-R2] or A3]-T3] above, where the composition generates a foam height≤20 cm, or ≤18 cm, or ≤16 cm, after 60 seconds of circulation as described herein (see experimental section).

V3] The process of any one of A]-R] or A3]-U3] above, or the composition of any one of A2]-R2] or A3]-U3] above, where the composition generates a foam height≥5.0 cm, after 60 seconds of circulation, as described herein.

W3] The process of any one of A]-R] or A3]-V3] above, or the composition of any one of A2]-R2] or A3]-V3] above, where the composition separates from oil and fills a “10 ml” volume in a time≤65, or ≤62, or ≤60, or ≤58, or ≤55, or ≤52 or ≤50, or ≤48, or ≤46, or ≤44, or ≤42, or ≤40 seconds, as determined by the emulsification evaluation, as described herein (see experimental section).

X3] The process of any one of A]-RJ or A3]-W3] above, or the composition of any one of A2]-R2] or A3]-W3] above, where the composition separates from oil and fills a “10 ml” volume in a time≥2 seconds.

Y3] The process of any one of A]-R] or A3]-X3] above, or the composition of any one of A2]-R2] or A3]-X3] above, where the composition separates from oil and fills a “5 ml” volume in a time≤30, or ≤28, or ≤25, or ≤22, or ≤20 or ≤18, or ≤16, or ≤14, or ≤12 seconds, as determined by the emulsification evaluation, as described herein (see experimental section).

Z3] The process of any one of A]-R] or A3]-Y3] above, or the composition of any one of A2]-R2] or A3]-Y3] above, where the composition separates from oil and fills a “5 ml” volume in a time≥1 seconds.

### EXPERIMENTAL

### Syntheses of Ether Amines

### Reductive Amination Catalyst

Each ether amine as described herein (Formula 1A and Formula 1B) was generated using a glycol ether starting material, and then performing a reductive amination reaction on the glycol ether. A solution containing “236 g Ni(NO₃)·6H₂O, 69 g Co(NO₃)₂·6H₂O, 51 g Cu(NO₃)₂·2.5 H₂O, 20.4 g NH₄ReO₄ and 59 g H₃BO₃ is prepared in 700 ml of boiling deionized water. This boiling solution is poured into a 1-L beaker containing 150 g of a catalyst support ( 1/16″ sphere alumina support available from UOP, under the trade designation SAB-17). This support mixture is thoroughly mixed to ensure complete and even wetting of the support. The impregnated support is dried in a crucible at 120° C. for 3 hours, with frequent stirring, and then calcined at 300° C. in an air furnace, for 3 hours, before being stored in a 120° C. oven, until activation.

The NiCoCuReB catalyst thus prepared, is reduced in an activation chamber. The temperature of the chamber is slowly heated to 350° C. over a period of two hours, while a stream of pure hydrogen gas flows through the chamber at about 30 ml/minute. Activation is continued for 4 hours, after the temperature reaches 350° C. The heat is then turned off, but the hydrogen flow is maintained, until the chamber cools to room temperature. The activated catalyst (pyrophoric) is carefully transferred into a bottle, in a nitrogen-filled dry box and stored there until use. The resulting catalyst has a total metal loading of 40 percent by weight. It contains a Ni/Co/Cu/Re/B metal weight ratio of 48/14/14/14/10, and a Ni/Co weight ratio of 3.4 and a Ni/Cu weight ratio of 3.4.

The catalyst is loaded into the reactor inside a nitrogen filled dry box (oxygen<10 ppm) to prevent deactivation. Ceramic sphere packing (⅛″) is used above and below the catalyst, so that the catalyst bed is positioned in the constant temperature zone of the reactor.

### Reductive Amination of the Glycol Ether

A continuous plug-flow reactor system is used for all reductive amination reactions. An ISCO model 500D continuous feed syringe pump system (maximum pressure of 3750 psi), with TEFLON seals, is used for the glycol ether solvent feed. A second ISCO model 500D syringe pump system is used to feed ammonia at constant flow rates. A Brooks model 5850TR mass flow controller (maximum pressure of 4500 psi), in conjunction with a model 5896 digital readout box, is used to control the hydrogen flow from a 6000 psig cylinder. A differential pressure regulator (AP=50 psig) from VERIFLO is used to regulate inlet/outlet bias pressure of the flow transducer. The three feed streams are combined and fed through a coiled preheater (⅛″ O.D., 316 stainless steel tubing, 15 feet total length) to a tubular, packed bed reactor. This 316 stainless steel Kuentzel-type reactor (1.25″ I.D., 250-ml capacity), made by Autoclave Engineers, is rated at 9,500 psi/500° F., and contains 200 ml of the catalyst. A 1/16″ diameter thermocouple, inserted from the top of the reactor to the center of the catalyst bed, is used to monitor the catalyst temperature. Reactor volume, not filled with catalyst, is filled with glass wool. The reactor pressure is maintained by a back-pressure control valve (BPCV, maximum pressure=6000 psi) manufactured by TESCOM Corporation. From the BPCV, the product solution is collected in a sample bottle.

The plug-flow reactor system is equipped with several automatic shutdown features to warrant around-the —clock unattended operations. The reactor controller has a high temperature cut-off sensor, and both ISCO feed pumps have high pressure cut-off capabilities. The hydrogen feed line is blocked by an actuator driven by two electric solenoid valves, whenever the high-pressure sensor or the high temperature sensor detects any over-the —limit reactor pressure or temperature, respectively.

The aminated glycol ethers are isolated as crude reaction mixtures containing residual ammonia, water, and some glycol ether starting material. The ammonia is removed by either bubbling nitrogen through the crude mixtures or by using an evaporator at low pressure (for example, a Büchi rotary evaporator). Further purification of each product is achieved by distillation.

### Typical Reaction Conditions

The reactor conditions used for the reductive amination of the glycol ethers are as follows: Reactor temperature=170-215° C., Reactor pressure=1200 psig, Glycol ether solvent feed rate=0.5-1.5 ml/minute, Liquid hourly space velocity (LHSV)=0.15-0.45, NH₃/OH molar ratio=20-25, Hydrogen level of 3-5 mole percent,

### Purification

To purify, the 1-methoxy-2-aminopropane (or 1-methoxypropan-2-amine) is treated first with NaOH pellets to create a separate water layer that is decanted prior to distillation to improve recovery. Analysis of purity is conducted by acid titration, Karl-Fisher water titration, gas chromatography and/or nuclear magnetic resonance spectroscopy.

A major portion of the water in the 1-methoxy-2-aminopropane is removed by the addition of NaOH pellets, which induce the formation of an aqueous caustic layer. In a typical experiment, the 1-methoxy-2-aminopropane (2000 g) is added to a 3 L, three-neck flask, shaped with an elongated bottom and fitted with an overhead stirrer and a bottom stopcock. The stirrer is turned on, and NaOH pellets (273 g) are added, scoop wise, to the flask, in an amount that results in an approximately “12 weight percent” concentration of NaOH, to the combined 1-methoxy-2-aminopropane/NaOH mixture. The mixture is allowed to stir overnight for a minimum of 12 hours. Stirring is arrested, and the phases allowed to separate. The bottom “water layer containing about 31 weight percent NaOH” is separated from the top “organic layer containing the 1-methoxy-2-aminopropane.” The resulting 1-methoxy-2-aminopropane contains approximately 5 weight percent water. The remaining ether amines are not dried using NaOH.

Each ether amine is distilled in either a “6 feet by 1.5 inch inside diameter” glass column or a “2 feet by 1 inch diameter” glass column (see Table 1). Both columns are fitted with overhead reflux splitters and packed with 0.25 inch ceramic saddles, and aside from scale, are identical in form and function. The ether amine is loaded into appropriately sized flasks for the amount of material available, and attached to the bottom of a distillation column. For 2-butoxy-1-aminoethane and 1-butoxy-2-aminopropane, the columns are flushed with nitrogen, placed under vacuum and then heated. The 1-methoxy-2-amino-propane is flushed with nitrogen, but distilled at atmospheric pressure. Light impurities are taken overhead first, followed by the desired ether amine. The samples are distilled until the level of sample in the bottom flask is no longer sufficient to ensure adequate coverage of the built-in thermocouple well. Cuts are taken at regular intervals, analyzed, and recombined based on purity. Information on distillation parameters is provided in Table 1.

Triplicate analysis of “0.15 g aliquots” of the (purified) ether amine, diluted in 60 ml of deionized water (DI water), are conducted using a Mettler Toledo DL67 titrator, equipped with a DG115-SC sensor and standardized 0.1M HCl titrant. Standardization of the HCl titrant is performed by titrating a known amount of potassium hydrogen phthalate with a NaOH solution, and then using the standardized NaOH solution to titrate the HCl.

Purity of the ether amine (aminated glycol ether) is determined using the following formula, and the purity is reported in Table 1 (purity by acid titration);

{[(ml “0.1 M HCl” to equivalence point)/10/grams sample titrated)]/[1000/molecular weight of animated glycol ether]}×100.

TABLE 1
Example Distillation Conditions and Purity

| | Column | Pressure | Reflux Ratio | Purity |
|---|---|---|---|---|
| Ether amine | (ft) | (mm Hg) | (Reflux/Product) | (%) |
| 2-butoxy-1-aminoethane | 6 | 46 | 10/1 | 98.8 |
| 1-methoxy-2-aminopropane | 6 | 742 | 10/1 | 97.4 |
| 1-butoxy-2-aminopropane | 2 | 35 | 10/2 | 99.8 |
| 1-propoxy-2-aminopropane | 2 | 35 | 10/2 | 96.1 |

The ether amines shown in Table 2 were prepared as discussed above. The crude reaction mixture, after the removal of ammonia, was purified by distillation. Two comparative amines are also shown Table 2.

TABLE 2
Ether Amines

| Ether Amine Abbreviation | Chemical Nomenclature and Structure |
|---|---|
| PM Amine CAS# 37143-54-7 | 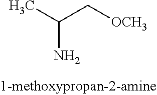 |
| DPM Amine CAS# 89979-85-1 | 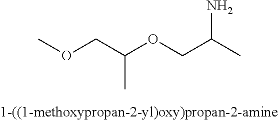 |
| DPnP CAS# 1614238-98-0 | 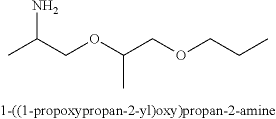 |
| TPnP | 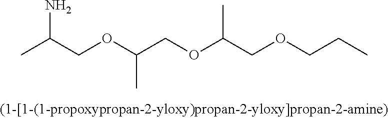 [SMILES: CCCOCC(C)OCC(C)OCC(C)N] |
| PnB Amine CAS# 98433-68-2 | 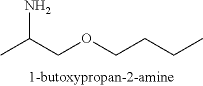 |
| DPnB Amine | 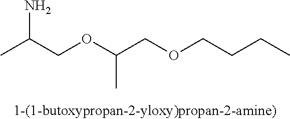 |
| TPM Amine | 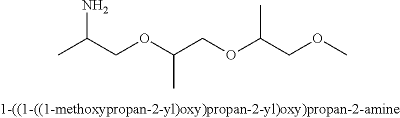 |
| DM Amine CAS# 31576-51-9 | 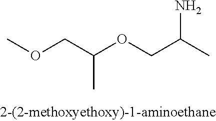 |
| EB Amine | 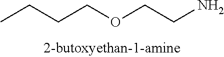 |
| | 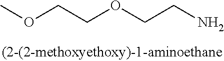 |
| MEA (Comparative) | 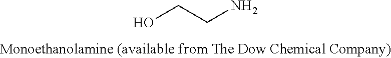 |
| MPA (Comparative) | 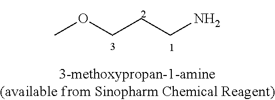 |

### Reagents and Coupon

Reagents and test coupon are listed in Table 3 below.

TABLE 3
Reagents and Test Coupon

| Name | Batch/Mode | Manufacturer |
|---|---|---|
| Stamping oil | 320A | Shanghai Parkerizing |
| 304 [type] stainless-steel coupon | 50 mm × 25 mm × 2 mm | Shanghai Luosong Equipment |
| | (top surface: 50 mm × 25 mm) | |
| ECOSURF LFE-635 (surfactant) | | The Dow Chemical Company |
| EDTA-4Na•4H2O (chelate) | SCRC-20181214 | Sinopharm Chemical Reagent |
| Paraffin Liquid (oil) | | Sinopharm Chemical Reagent |

### Compositions

Inventive and comparative compositions are shown in Table 4A and Table 4B below. Each composition was prepared by mixing the noted reagents at room temperature. The required EDTA-4Na·4H2O was dosed into DI water and mix until dissolved. Then, the ether amine and the LFE-635 were added into the solution, and the final solution was mix until a homogeneous suspension or a complete dissolution was formed.

TABLE 4A
Cleaning Compositions*

| | | | | Wt % | Wt % | Weight Ratio of |
|---|---|---|---|---|---|---|
| | | Wt % | Wt % | EDTA- | Deionized | Ether Amine to |
| Composition | Ether Amine | Amine | LFE-635 | 4Na•4H2O | Water (DI) | Chelate |
| Example 1 | PM Amine | 2.0 | 0.1 | 0.5 | 97.4 | 4.0 |
| Example 2 | DPM Amine | 2.0 | 0.1 | 0.5 | 97.4 | 4.0 |
| Example 3 | DPnP Amine | 2.0 | 0.1 | 0.5 | 97.4 | 4.0 |
| Example 4 | TPnP Amine | 2.0 | 0.1 | 0.5 | 97.4 | 4.0 |
| Example 5 | PnB Amine | 2.0 | 0.1 | 0.5 | 97.4 | 4.0 |
| Example 6 | DPnB Amine | 2.0 | 0.1 | 0.5 | 97.4 | 4.0 |
| Comparative 1 | MEA | 2.0 | 0.1 | 0.5 | 97.4 | 4.0 |
| Comparative 2 | 3-methoxy- | 2.0 | 0.1 | 0.5 | 97.4 | 4.0 |
| | propylamine | | | | | |

*Each wt % based on the weight of the composition.

TABLE 4B
Cleaning Compositions*

| | | | | Wt % | Wt % | Weight Ratio of |
|---|---|---|---|---|---|---|
| | | Wt % | Wt % | EDTA- | Deionized | Ether Amine to |
| Composition | Ether Amine | Amine | LFE-635 | 4Na•4H2O | Water (DI) | Chelate |
| Example 3 | DPnP Amine | 2.0 | 0.1 | 0.5 | 97.4 | 4.0 |
| Example 7 | DPnP Amine | 2.0 | 0.1 | 5.5 | 92.4 | 0.36 |
| Example 8 | DPnP Amine | 2.0 | 0.1 | 0.008 | 97.892 | 250 |

*Each wt % based on the weight of the composition.

### Testing and Results

### Metal Cleaning Performance Evaluation

A stainless steel (ss) coupon was washed under running DI water for about 10 seconds, and then rinsed by spraying acetone from a squeeze bottle onto the coupon, until all the surfaces on the coupon were covered. The washed and rinsed coupon was blow-dried at room temperature and then weighed. The weight of the dried ss coupon was recorded as W1.

A cleaning composition (45 g, see Table 4A or Table 4B) was added to a 50 mL PP bottle. The dried ss coupon was tared on a scale, and stamping oil (0.20 g+/−0.01 g) was applied to the top surface of the coupon by a drip tube. The coupon was carefully rotated to ensure the oil was evenly spread on the coupon surface. The weight of the soiled coupon was recorded as W2.

The soiled coupon was placed into the cleaning composition (50 ml bottle) using a tweezer, and a timer was immediately started. After five minutes, the coupon was taken out of the composition, and rinsed by putting the coupon into 200 mL of DI water (in a 250 mL beaker) for about 3-5 seconds.

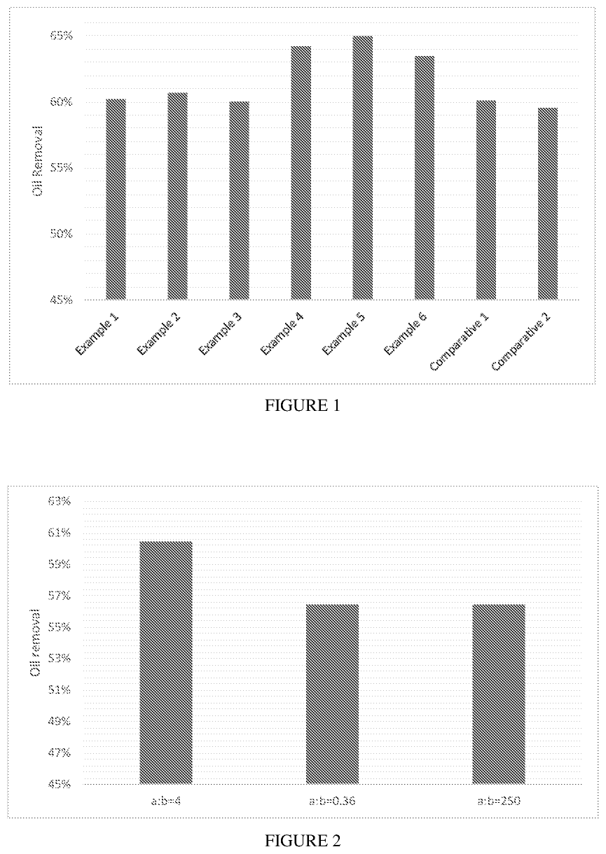

The rinsed coupon was paced in a metal tray (“top surface” facing up) situated on top of a laboratory benchtop, and the coupon was air dried at room temperature for a day. The weight of the dried coupon was recorded as W3. The percentage of the oil removed by the cleaning composition (or “oil removal %”) was calculated using the following formula: [(W2−W3)/(W2−W1)]×100. Results are shown in FIG. 1 and FIG. 2. For FIG. 1, three test coupons were examined per composition and an average reported (Relative Standard Deviation (RSD)=2.7%).

As seen in FIG. 1, Examples 1-6 show equivalent or better removal of the oil, as compared to Comparative Examples 1 and 2. It is noted that Comparative 1 (MEA) is widely used in industrial cleaning applications, including metal cleaning. The results of this study indicate that the inventive compositions containing the noted ether amines are good replacements for current amine product in metal cleaners.

As seen in FIG. 2 (one test coupon per additional composition), for the same ether amine, the composition (Example 3, a/b=4.0) that has a weight ratio of ether amine to chelate that falls within the range from 0.40 to 200 outperforms the respective compositions that fall below (Example 7, a/b=0.36) and above (Example 8, a/b=250) this range.

### Foaming Evaluation

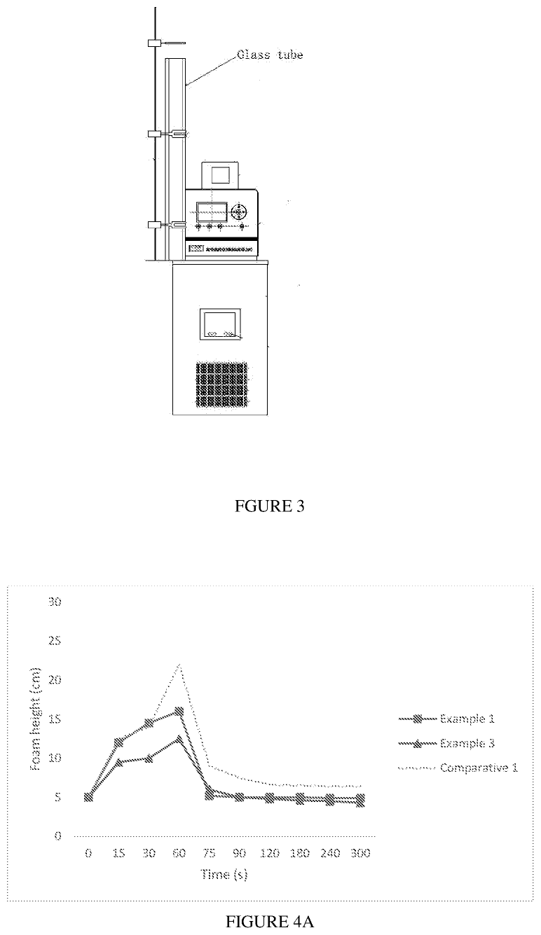

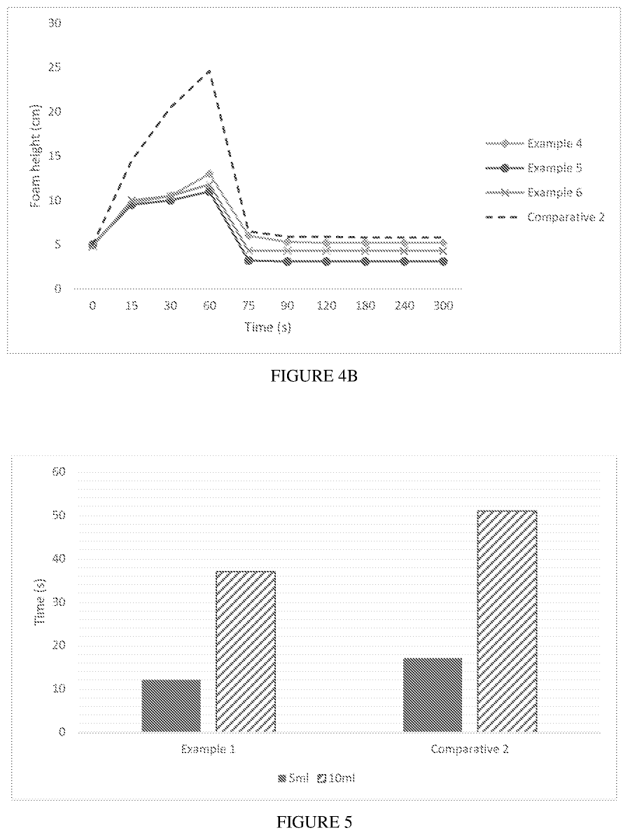

The cleaning composition (750 ml, see Table 4A and Table 4B) was poured into the glass tube of a circulating foam tester (see FIG. 3, Golden Chemical, Model: GT-2). When no additional foam was observed on the composition surface in the tube, a tester was turned on (voltage=27.8 V), which circulated the cleaning composition to generate a foam. Foam was generated for one minute, and the foam height at the following times was recorded: 15 seconds, 30 seconds, 60 seconds. After 60 seconds, the tester (circulation) was turned off, and the foam height at the following times was recorded: 75 seconds, 90 seconds, 120 seconds, 180 seconds, 240 seconds and 300 seconds. Examples 1 and 3-6 were compared with Comparative Example 1 and Comparative Example 2. See FIGS. 4A and 4B.

As seen in FIG. 4A, Examples 1 and 3 each outperformed Comparative 1. In FIG. 4B, Examples 4-6 each outperformed Comparative 2. As shown in each figure, during the foam generation stage, the foam height of each inventive composition did not increase as much as that of the comparative composition. Furthermore, after the circulation was stopped, the residue foam levels of the inventive compositions were lower than the levels of the comparative composition. The ability of a cleaning composition to generate a low amount of foam is an important consideration for metal cleaning compositions, especially those compositions used in a large scale metal cleaning process. Excess foaming may result in insufficient rinsing of the metal surface and/or in bath overflows and spills, leading to product waste. Also, good foam control, as seen in each inventive composition, reduces or eliminates the need for an additional foam control agent.

### Emulsification Evaluation

Paraffin liquid was used as the oil phase. A cleaning composition (20 ml, see Table 4A and Table 4B) was added to a graduated cylinder (100 ml), and this addition was followed by 20 ml of the oil. The cylinder was shaken, up and down, for ten times as one cycle. The “up and down” shaking was repeated for five cycles, with an interval of one minute between cycles. After the five cycles were completed, the times needed for the water phase to separate from the oil and reach the 5 ml and then the 10 ml calibration marks were recorded. A longer separation time indicated a stronger emulsification of the cleaning composition and the oil. Example 1 was compared with Comparative 2. See FIG. 5 (5 ml and 10 ml marks).

As seen in FIG. 5, Example 1 had a lower emulsifying strength towards the oil, as compared to Comparative 2. Emulsification is usually related to the chemical structure. Example 1 (PM amine) and Comparative 2 (MPA) share same molecular formula. PM amine has a branched methyl group, but MPA is of linear structure, which resulted in the difference in emulsification of the oil. Example 1 (PM amine) showed faster oil separation which is beneficial to long lasting cleaning bath life. This feature is advantageous in metal cleaning processes, since the cleaning solution is expected to quickly separate from oil after cleaning the metal. A strong binding with an oil may lead to a significant decrease in the efficacy of a cleaning bath, and thus to a shorter bath life. The results herein indicate that Example 1 is an optimal cleaning composition for an efficient oil separation and a longer bath life.

1. A process to clean a metal surface, the process comprising applying to the metal surface a composition comprising at least the following components a) and b):
a) at least one ether amine selected from Formula 1A and/or at least one ether amine selected from Formula 1B: 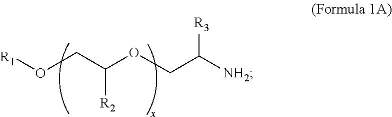
wherein R1 is a monovalent carbon-containing group comprising from 1 to 10 carbon atoms; R2 is a hydrogen, methyl, or ethyl; R3 is a hydrogen, methyl, or ethyl; and x is from 1 to 5; and when x≥2, the R2 groups of the —(CH₂—CHR2—O)— moieties may be all the same, or some or all different, and if some or all different, the [symbol]
—(CH₂—CHR2—O)ₓ—moieties may contain any combination of hydrogen and/or methyl and/or ethyl as at least two different R2 groups; 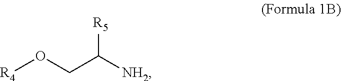
wherein R4 is a monovalent carbon-containing group comprising from 1 to 10 carbon atoms; and R5 is a hydrogen, methyl, or ethyl;
b) at least one chelate.

2. The process of claim 1, wherein the weight ratio of component a to component b is from 0.40 to 200.

3. The process of claim 1 wherein component b is a metal chelate.

4. The process of claim 1, wherein, for Formula 1A, R1 is an alkyl group; R2 is hydrogen or methyl; and R3 is hydrogen or methyl; and for Formula 1B, R4 is an alkyl group, and R5 is hydrogen or methyl.

5. The process of claim 1, wherein component a is selected from the following structures (1a) through (1j):

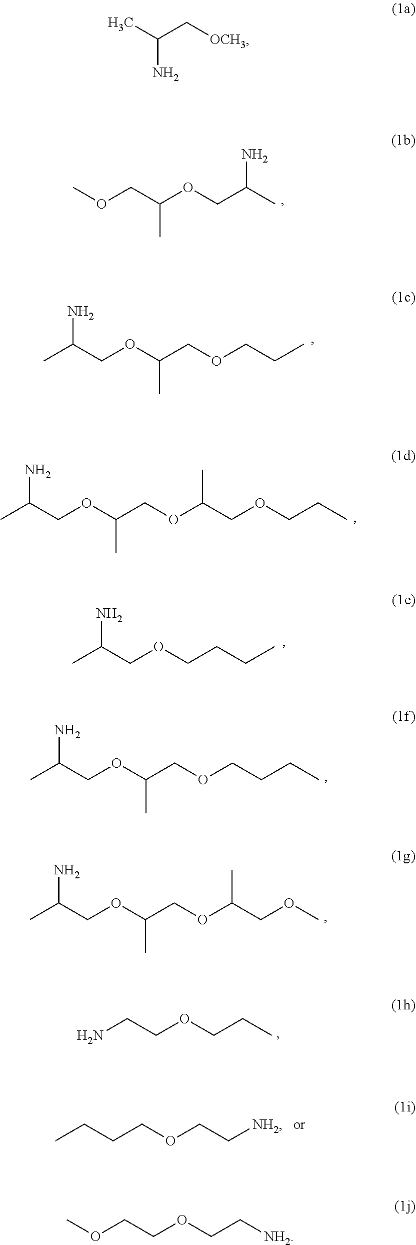

6. The process of claim 1, wherein component a is selected from the following structures: (1a), (1b), (1c), (1d), (1e) or (1f), each as shown above.

7. The process of claim 1, wherein component a is at least one ether amine selected from Formula 1A.

8. The process of claim 1, wherein component a is at least one ether amine selected from Formula 1B.

9. The process of claim 1, wherein the metal of the metal surface is selected from steel, stainless steel, brass, chrome, iron, aluminum, copper or gold.

10. A composition comprising at least the following components a) and b):
a) at least one ether amine selected from Formula 1A and/or at least one ether amine selected from Formula 1B: 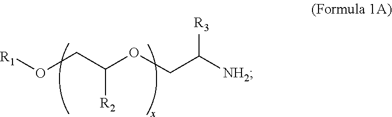
wherein R1 is a monovalent carbon-containing group comprising from 1 to 10 carbon atoms; R2 is a hydrogen, methyl, or ethyl; R3 is a hydrogen, methyl, or ethyl; and x is from 1 to 5; and when x≥2, the R2 groups of the —(CH₂—CHR2—O)— moieties may be all the same, or some or all different, and if some or all different, the [symbol]
—(CH₂—CHR2—O)ₓ— moieties may contain any combination of hydrogen and/or methyl and/or ethyl as at least two different R2 groups; 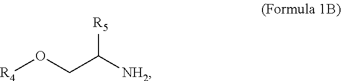
wherein R4 is a monovalent carbon-containing group comprising from 1 to 10 carbon atoms; and R5 is a hydrogen, methyl, or ethyl;
b) at least one chelate.

11. The composition of claim 10, wherein the weight ratio of component a to component b is from 0.40 to 200.

12. The composition of claim 10, wherein, for Formula 1A, R1 is an alkyl group; R2 is hydrogen or methyl; and R3 is hydrogen or methyl; and for Formula 1B, R4 is an alkyl group,; and R5 is hydrogen or methyl.

13. The composition of claim 10, wherein component a is selected from the following structures (1a) through (1j), each as shown above.

14. The composition of claim 10, wherein component a is selected from the following structures: (1a), (1b), (1c), (1d), (1e) or (1f), each as shown above.

15. The composition of claim 10, wherein component a is at least one ether amine selected from Formula 1A.

16. The composition of claim 10, wherein component a is at least one ether amine selected from Formula 1B.

17. The composition of claim 10, where the composition further comprises water.

18. The composition of claim 10, where the composition further comprises at least one surfactant as component c.

19. The composition of claim 10, where the composition further comprises at least one alkaline salt as component d.

20. The composition of claim 10, where the sum of component a and component b and water is present in an amount from 80 wt % to 100 wt %, based on the weight of the composition.
